(19) United States
(12) Patent Application Publication
(10) Pub. No.: US 2026/0208758 A1
(43) Pub. Date: Jul. 23, 2026

(54) KEEP-AWAY STEERING CONTROL STRATEGY FOR AUTONOMOUS DRIVING

(71) Applicant: GM Global Technology Operations LLC, Detroit, MI (US)

(72) Inventors: Peitong Hu, North York (CA); Amirreza Mirbeygi Moghaddam, North York (CA); Reza Zarringhalam, Whitby (CA); Mohammadali Shahriari, Markham (CA); Avshalom Suissa, Ganei Tikva (IL)

(21) Appl. No.: 19/031,576

(22) Filed: Jan. 18, 2025

(51) Int. Cl. B60W 60/00; B60W 10/20; B60W 30/16

(52) U.S. Cl. CPC B60W 60/001; B60W 10/20; B60W 30/16; B60W 2420/403; B60W 2552/53; B60W 2554/80

(57) ABSTRACT

A vehicle includes system for operating the vehicle. The system includes a perception sensor and a processor. The perception sensor is configured to detect a remote object in a road section. The processor is configured to determine a repelling potential associated with the remote object, determine an attractor potential based on an estimated location of a lane marker, determine a trajectory for the vehicle based on the repelling potential and the attractor potential, create a cost function for the vehicle based on the trajectory and at least one candidate steering command, perform an optimization procedure on the cost function to determine an optimal steering command for the vehicle from the at least one candidate steering command, and control a movement of the vehicle along the road section using the optimal steering command.

The subject disclosure relates to vehicles and, in particular, to a system and method of controlling a trajectory of a vehicle in the absence of information regarding lane markers of a road being travelled.

Autonomous vehicles include perception sensors that provide information that can be used to plan a trajectory for the vehicle and move the vehicle along the trajectory. For example, a radar sensor can provide spatial information regarding remote objects, such as remote vehicles, pedestrians, etc. A digital camera can provide information about lane markers, etc. Accordingly, it is desirable to provide a system and method of planning a trajectory that can be used when lane marker information is not available.

### SUMMARY

In one exemplary embodiment, a method of operating a vehicle is disclosed. A remote object is detected in a road section. A repelling potential associated with the remote object is determined. An attractor potential is determined based on an estimated location of a lane marker. A trajectory for the vehicle is determined based on the repelling potential and the attractor potential. A cost function is created for the vehicle based on the trajectory and at least one candidate steering command. An optimization procedure is performed on the cost function to determine an optimal steering command for the vehicle from the at least one candidate steering command. A movement of the vehicle along the road section is controlled using the optimal steering command.

In addition to one or more of the features described herein, the method further includes determining the repelling potential based on an inverse of a distance between the vehicle and the remote object.

In addition to one or more of the features described herein, the method further includes defining a radius of awareness and determining the repelling potential as one of proportional to an inverse of the distance between the vehicle and the remote object when the distance is less than or equal to the radius of awareness and zero when the distance is greater than the radius of awareness.

In addition to one or more of the features described herein, the method further includes determining the attractor potential using a lateral distance between the vehicle and the estimated location of the lane marker.

In addition to one or more of the features described herein, the method further includes determining the estimated location of the lane marker by performing a Galilean transformation on a current location of the vehicle using a longitudinal velocity of the vehicle and a lateral velocity of the vehicle at the current location of the vehicle.

In addition to one or more of the features described herein, the method further includes creating the cost function when one of a malfunction of a camera occurs at the vehicle and the road section has no lane markers.

In addition to one or more of the features described herein, controlling the movement of the vehicle further comprises controlling a lateral movement of the vehicle.

In another exemplary embodiment, a system for operating a vehicle is disclosed. The system includes a perception sensor and a processor. The perception sensor is configured to detect a remote object in a road section. The processor is configured to determine a repelling potential associated with the remote object, determine an attractor potential based on an estimated location of a lane marker, determine a trajectory for the vehicle based on the repelling potential and the attractor potential, create a cost function for the vehicle based on the trajectory and at least one candidate steering command, perform an optimization procedure on the cost function to determine an optimal steering command for the vehicle from the at least one candidate steering command, and control a movement of the vehicle along the road section using the optimal steering command.

In addition to one or more of the features described herein, the processor is further configured to determine the repelling potential based on an inverse of a distance between the vehicle and the remote object.

In addition to one or more of the features described herein, the processor is further configured to define a radius of awareness and determine the repelling potential as one of proportional to an inverse of the distance between the vehicle and the remote object when the distance is less than or equal to the radius of awareness and zero when the distance is greater than the radius of awareness.

In addition to one or more of the features described herein, the processor is further configured to determine the attractor potential using a lateral distance between the vehicle and the estimated location of the lane marker.

In addition to one or more of the features described herein, the processor is further configured to determine the estimated location of the lane marker by performing a Galilean transformation on a current location of the vehicle using a longitudinal velocity of the vehicle and a lateral velocity of the vehicle at the current location of the vehicle.

In addition to one or more of the features described herein, the processor is further configured to create the cost function when one of a malfunction of a camera occurs at the vehicle and the road section has no lane markers.

In addition to one or more of the features described herein, controlling the movement of the vehicle further comprises controlling a lateral movement of the vehicle.

In yet another exemplary embodiment, a vehicle is disclosed. The vehicle includes a perception sensor, an actuator and a processor. The perception sensor is configured to detect a remote object in a road section. The actuator controls a movement of the vehicle. The processor is configured to determine a repelling potential associated with the remote object, determine an attractor potential based on an estimated location of a lane marker, determine a trajectory for the vehicle based on the repelling potential and the attractor potential, create a cost function for the vehicle based on the trajectory and at least one candidate steering command, perform an optimization procedure on the cost function to determine an optimal steering command for the vehicle from the at least one candidate steering command, and send the optimal steering command to the actuator to control a movement of the vehicle along the road section.

In addition to one or more of the features described herein, the processor is further configured to determine the repelling potential based on an inverse of a distance between the vehicle and the remote object.

In addition to one or more of the features described herein, the processor is further configured to define a radius of awareness and determine the repelling potential as one of proportional to an inverse of the distance between the vehicle and the remote object when the distance is less than or equal to the radius of awareness and zero when the distance is greater than the radius of awareness.

In addition to one or more of the features described herein, the processor is further configured to determine the attractor potential using a lateral distance between the vehicle and the estimated location of the lane marker.

In addition to one or more of the features described herein, the processor is further configured to determine the estimated location of the lane marker by performing a Galilean transformation on a current location of the vehicle using a longitudinal velocity of the vehicle and a lateral velocity of the vehicle at the current location of the vehicle.

In addition to one or more of the features described herein, the processor is further configured to create the cost function when one of malfunction of a camera occurs at the vehicle and the road section has no lane markers.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle with a trajectory planning system, in accordance with an exemplary embodiment;

FIG. 2 shows a top view of a road section, in an illustrative embodiment;

FIG. 3 shows a top view of the road section without lane markers or center lines;

FIG. 4 shows a top view of the road section with remote objects marked for trajectory planning purposes;

FIG. 5 shows a top view of the road section with a trajectory generated using the methods disclosed herein;

FIG. 6 shows a block diagram depicting operation of an Advanced Driver Assistance System (ADAS) in the absence of lane marker data and center line data, in an illustrative embodiment;

FIG. 7 shows an exemplary scenario depicting various remote vehicles in relation to the host vehicle;

FIG. 8 is a top view of a host vehicle and illustrates a method for estimating a location for a lane marker using the method disclosed herein; and

FIG. 9 is a top view of the road section showing various attractor potentials based on generated lane marker locations.

### DETAILED DESCRIPTION

The following description is merely exemplary in nature and is not intended to limit the present disclosure, its application or uses. It should be understood that throughout the drawings, corresponding reference numerals indicate like or corresponding parts and features.

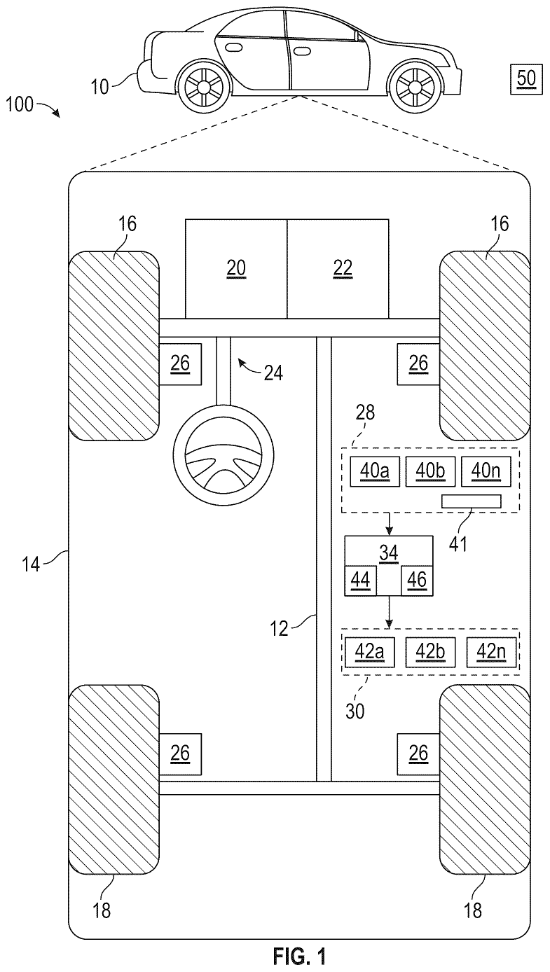

In accordance with an exemplary embodiment, FIG. 1 shows an autonomous vehicle 10 with a trajectory planning system 100. In general, the trajectory planning system 100 determines a trajectory plan for automated driving of the autonomous vehicle 10. The autonomous vehicle 10 generally includes a chassis 12, a body 14, front wheels 16, and rear wheels 18. The body 14 is arranged on the chassis 12 and substantially encloses components of the autonomous vehicle 10. The body 14 and the chassis 12 may jointly form a frame. The front wheels 16 and rear wheels 18 are each rotationally coupled to the chassis 12 near respective corners of the body 14.

In various embodiments, the trajectory planning system 100 is incorporated into the autonomous vehicle 10. The autonomous vehicle 10 is, for example, a vehicle that is automatically controlled to carry passengers from one location to another. The autonomous vehicle 10 is depicted in the illustrated embodiment as a passenger car, but it should be appreciated that any other vehicle including motorcycles, trucks, sport utility vehicles (SUVs), recreational vehicles (RVs), etc., can also be used. At various levels, an autonomous vehicle can assist the driver through a number of methods, such as warning signals to indicate upcoming risky situations, indicators to augment situational awareness of the driver by predicting movement of other agents warning of potential collisions, etc. The autonomous vehicle 10 has different levels of intervention or control of the vehicle through coupled assistive vehicle control all the way to full control of all vehicle functions. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, and a controller 34. The propulsion system 20 may, in various embodiments, include an internal combustion engine, an electric machine such as a traction motor, and/or a fuel cell propulsion system. The transmission system 22 is configured to transmit power from the propulsion system 20 to the front wheels 16 and rear wheels 18 according to selectable speed ratios. According to various embodiments, the transmission system 22 may include a step-ratio automatic transmission, a continuously variable transmission, or other appropriate transmission. The brake system 26 is configured to provide braking torque to the front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The sensing devices 40a-40n obtain measurements or data related to various objects or agents 50 within the vehicle's environment. Such agents 50 can be, but are not limited to, other vehicles, pedestrians, bicycles, motorcycles, etc., as well as non-moving objects. The sensing devices 40a-40n can also obtain traffic data, such as information regarding traffic signals and signs, etc.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but not limited to, doors, a trunk, and cabin features such as ventilation, music, lighting, etc. (not numbered).

The controller 34 includes a processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. The instruction may also perform logic, calculations, methods and/or algorithms for placing artificial potential fields around remote objects, planning a trajectory for the vehicle based on the artificial potential fields, and moving the vehicle along the trajectory, using the methods disclosed herein.

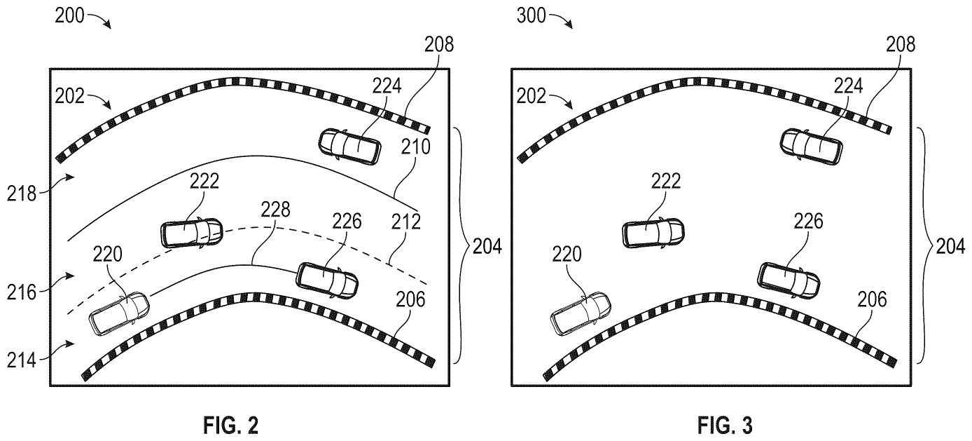

FIG. 2 shows a top view 200 of a road section 202, in an illustrative embodiment. The road section 202 includes a carriageway 204 defined by a first road boundary 206 and a second road boundary 208 along the outer edges of the road section. The first road boundary 206 and the second road boundary 208 can be physical edges or solid lines that indicate the sides of the carriageway 204. A center line 210 separates the carriageway 204 into two-way traffic. For traffic moving in a first direction, a lane marker 212 separates the traffic into a first lane 214 and a second lane 216. There is a single lane (i.e., a third lane 218) for traffic moving in a second direction opposite the first direction.

A host vehicle 220 is located in the first lane 214. A first remote vehicle 222 is located in a second lane 216 and is moving in the same direction as the host vehicle 220. A second remote vehicle 224 is located in the third lane 218 and is moving in a direction opposite the host vehicle 220. A third remote vehicle 226 is located in the first lane 214 in front of the host vehicle 220 and moving in the same direction as the host vehicle. Also shown is a trajectory 228 for the host vehicle 220 that is based on knowledge of the remote objects, lane markers, center lines, etc.

It is understood that the road section 202, including the configuration of lanes, locations of vehicles within the lanes, etc., are shown only for illustrative purposes. The methods disclosed herein apply to road sections having different configurations, different number of vehicles, different locations of vehicles, etc.

FIG. 3 shows a top view 300 of the road section 202 without lane markers or center lines. For various reasons, sensors at the host vehicle 220 are unable to detect center line 210 and lane marker 212 for the road section 202. The first road boundary 206, second road boundary 208, first remote vehicle 222, second remote vehicle 224, and third remote vehicle 226 are still being detected.

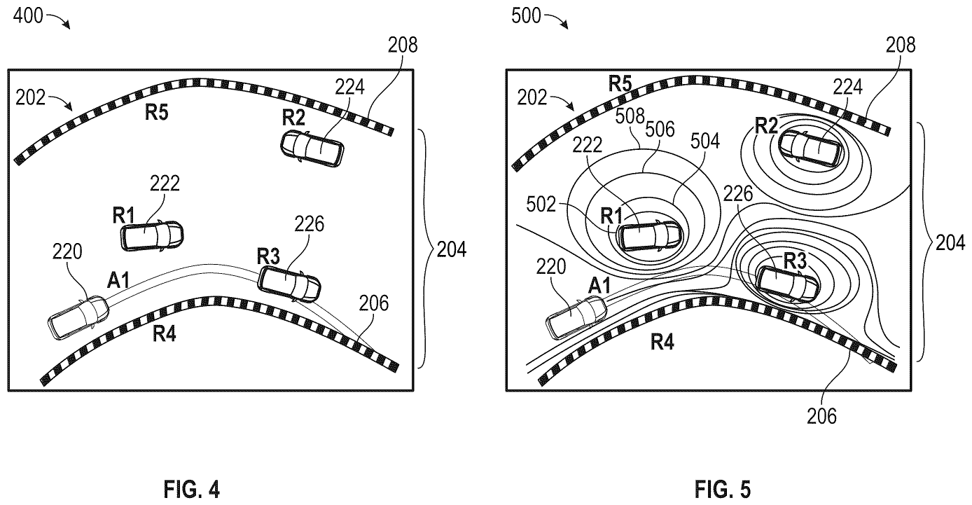

FIG. 4 shows a top view 400 of the road section 202 with remote objects marked for trajectory planning purposes. Remote objects that the host vehicle wants to avoid are marked as Repellers (e.g., R1, R2, R3), while locations that the host vehicle wants to stay near are marked as Attractors (e.g., A1). The first remote vehicle 222 is marked as a first Repeller (R1). The second remote vehicle 224 is marked as a second Repeller (R2). The third remote vehicle 226 is marked as a third Repeller (R3). The first road boundary 206 is marked as a fourth Repeller (R4) and the second road boundary 208 is marked as a fifth Repeller (R5). A single Attractor A1 is shown based on an estimated lane marker location.

FIG. 5 shows a top view 500 of the road section 202 with a trajectory generated using the methods disclosed herein. To plan a trajectory for the host vehicle 220, the Repellers are modelled with an artificial potential that exerts a repelling force on the host vehicle, and an Attractor is modelled with an artificial potential that exerts an attracting force on the host vehicle. As an example, potential lines 502, 504, 506 and 508 surround the first Repeller (R1). The repellent force associated with each potential line decreases with the radial distance of the potential line from the first Repeller (R1). An attractive force for the Attractor increases quadratically with distance from the Attractor. A trajectory is planned that avoids the locations of the various Repellers and staying near the Attractor(s). The trajectory is calculated based on the location and strength of the potential lines.

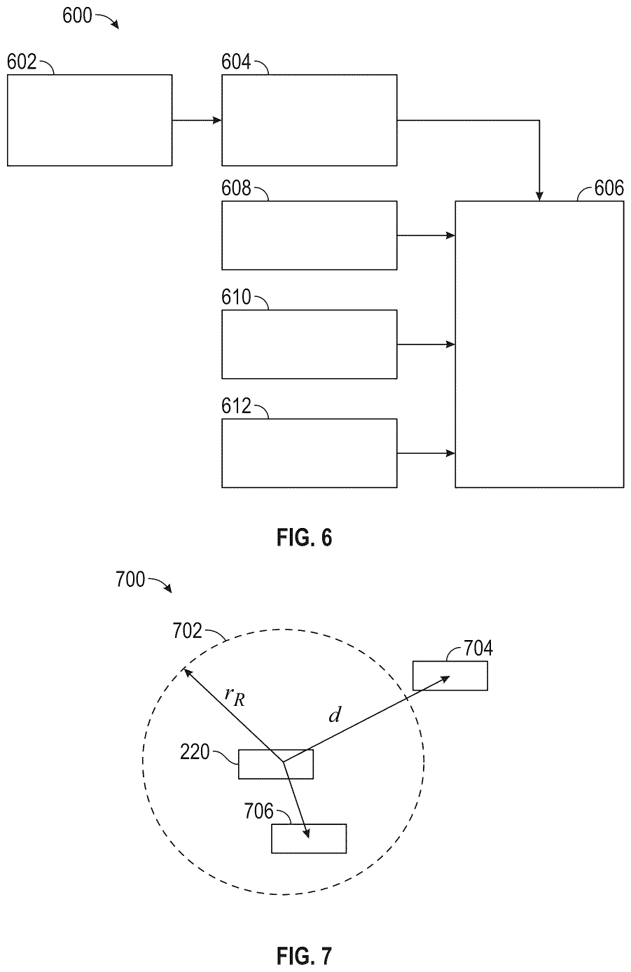

FIG. 6 shows a block diagram 600 depicting operation of an Advanced Driver Assistance System (ADAS) in the absence of lane marker data and center line data, in an illustrative embodiment. The system includes a perception system 602, a field generator 604 and a model predictive controller 606. The perception system 602 can include radar, Lidar, GPS, IMU, and/or other perception systems that gives information regarding a relation of the host vehicle to various objects within the environment of the host vehicle. The perception system 602 does not provide data regarding lane markers or road markings. This lack of lane marker information can be due to loss of or malfunction of a camera or optical sensor or due to traveling on a road section without these markings.

The field generator 604 generates artificial potential fields (sch as shown in FIG. 5) associated with the various objects within the environment, such as remote vehicles, pedestrians, cyclists, guard rails, etc. The potential fields are provided to a model predictive controller 606. The model predictive controller 606 defines a trajectory for the vehicle using the potential fields are used. The repelling potentials and attractor potentials can be combined to form an aggregate potential for the road section, and the trajectory can be generated along a minimum or maximum potential of the aggregate potential. The model predictive controller 606 determines steering trajectories using a plant model 608 for the vehicle, various adaptive weights 610 for the potentials and steering and steering constraints 612. The model predictive controller 606 creates a cost function based on the trajectory and a candidate steering command provided from a steering system. The candidate steering command can be a steering angle of a steering wheel, for example, but can also include acceleration and deceleration terms. The candidate steering command is used to estimate a predicted steering path at a future position of the vehicle. The cost function can be calculated by determining attractive forces and repelling forces on the vehicle at the future position. The cost function can be calculated for a plurality of candidate steering commands. The model predictive controller 606 performs an optimization procedure on the cost function in order to determine an optimal steering command that moves the host vehicle along the trajectory. The optimal steering command is associated with a minimized cost selected the optimization procedure. The model predictive controller 606 can provide the optimal steering command to various actuators (i.e., actuator devices 42a-42n) of the vehicle in order to move the host vehicle along the trajectory. Moving the host vehicle along the trajectory can include controlling a lateral movement of the host vehicle.

The model predictive controller 606 generates a cost function that is a sum of errors between the repellant fields and the attractive fields at the predicted future position. As an example, a cost function for the illustrative scenario shown in FIG. 5 is shown in Eq. (1):

$$C = {\sum }_{k = 1}^{p} \{ {c}_{1} {w}_{1} {ϵ}_{( {y}_{k} , {R}_{1} )}^{- 2} + {c}_{2} {w}_{2} {ϵ}_{( {y}_{k} , {R}_{2} )}^{- 2} + {c}_{3} {w}_{3} {ϵ}_{( {y}_{k} , {R}_{3} )}^{- 2} + {c}_{4} {w}_{4} {ϵ}_{( {y}_{k} , {A}_{1} )}^{2} + {{w}_{Δ u} ( {u}_{k} - {u}_{k - 1} )}^{2} + {{w}_{u} ( {u}_{k} - {u}_{ref} )}^{2} \} \qquad Eq ( 1 )$$

where the first three terms within the summation are the repelling potential fields of the first remote vehicle 222, the second remote vehicle 224, and the third remote vehicle 226, respectively. The fourth term within the summation is an actuator potential field. The fifth term is related to a change in steering angle over a discrete time step. The sixth term describes a difference between a candidate steering wheel angle and reference steering wheel angle. The summation is over p time steps, where p is a prediction horizon for the model predictive controller 606.

Referring to the first term

$$( {c}_{1} {w}_{1} {ϵ}_{( {y}_{k} , {R}_{1} )}^{- 2} ) ,$$

c₁ is a detection confidence coefficient, w₁ is a weight term that is scaled based on historical data, and ϵ_{(y}_{ₖ}_{,R}_{₁}₎ is a distance potential between the host vehicle (i.e., the lateral coordinate yₖ of the host vehicle) and the first remote vehicle 222 (i.e., first Repeller R₁). The second term and third term are similar to the first term.

FIG. 7 shows an exemplary scenario 700 depicting various remote vehicles in relation to the host vehicle 220. Circle 702 defines a radius of awareness r_{R}. A first object 704 is outside of the circle 702 and a second object 706 is inside the circle. The distance potential E for any remote object is given by Eq. (2):

$$ϵ = \{ \begin{matrix}{k}_{R} ( {d}^{- 1} - {r}_{R}^{- 1} ) , & d \leq {r}_{R} \\ 0 , & d > {r}_{R}\end{matrix} \qquad Eq . ( 2 )$$

where d is a Euclidean distance between the host vehicle and the remote vehicle and r_{R} is the radius of awareness and k_{R} is a repelling constant. The Euclidean distance d is given by Eq. (3):

$${d}_{( a , b )} = \sqrt{{\sum }_{i = 1}^{n} {( {a}_{i} - {b}_{i} )}^{2}} \qquad Eq . ( 3 )$$

where ai are the position coordinates of the host vehicle and bi are the position coordinates of the remote object. When the distance d is greater than or equal to the radius of awareness, the potential is zero. When the distance is less than the radius of awareness r_{R}, the potential is proportional to a difference of the inverse of the Euclidean distance (1/d) and the inverse of the radius of awareness (1/r_{R}). Thus, for the first object 704, the potential is zero and for the second object 706, the potential is k_{R}(1/d−1/r_{R}).

Further in the cost function of Eq. (1), the fourth term

$$( {c}_{4} {w}_{4} {ϵ}_{( {y}_{k} , {A}_{1} )}^{2} )$$

includes a detection confidence coefficient c₄, a weight term w₄ scaled based on historical data, and a distance potential ϵ_{(y}_{ₖ}_{,A}_{₁}₎ based on a lateral distance between the host vehicle an estimated location for a lane marker, as shown in Eq. (4):

$$ϵ = {{k}_{A} ( y - A )}^{2} \qquad Eq . ( 4 )$$

where k_{A} is an attraction constant, y is a lateral coordinate of the vehicle and A is a lateral coordinate of the Attractor.

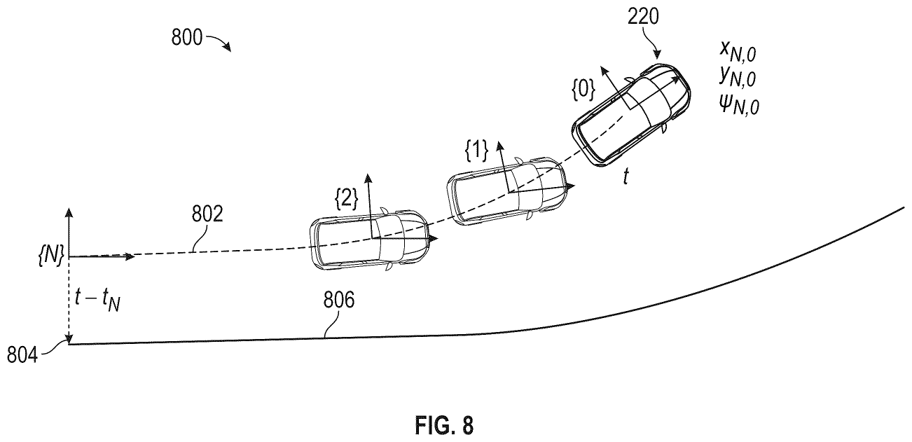

FIG. 8 is a top view 800 of a host vehicle 220 and illustrates a method for estimating a location for a lane marker using the method disclosed herein. The top view 800 shows a section of a path 802 travelled by the host vehicle 220 over N time steps. The host vehicle 220 is located at a current location {0} at current timestep t. An N^{th} location {N} indicates a location at which reliable information about the lane marker is last received. This can be a location at which the relevant perception sensor malfunctioned, for example. The method determines a calculated location for the lane marker at time t−N (location {N}) using a series of Galilean transformations through intermediate locations (i.e., {1}, {2}, . . . ). A transformation of velocities from a body centered reference frame of the vehicle to a reference from of the road section is shown in Eqs. (5)-(7):

$${\dot{x}}_{gbl} = cos ( ψ ) {V}_{x} - sin ( ψ ) {V}_{y} \qquad Eq . ( 5 )$$

$${\dot{y}}_{gbl} = cos ( ψ ) {V}_{y} + sin ( ψ ) {V}_{x} \qquad Eq . ( 6 )$$

$$\dot{ψ} = {ω}_{z} \qquad Eq . ( 7 )$$

where Vₓ is the body-centered longitudinal velocity of the vehicle, V_{y} is the body-centered lateral velocity of the vehicle and ψ is the yaw angle of the vehicle, and x_{gbl} and y_{gbl} are global coordinates in the frame of the vehicle at the initial step.

The velocities of the vehicle (i.e., the longitudinal velocity Vₓ and the lateral velocity V_{y}) for the last N timesteps are retained in memory by the host vehicle and are used for the Galilean transformation. Over time, the longitudinal and lateral coordinates of the vehicle at time t−N can be determined by applying the Galilean transformations through each of the locations ({0}, {1}, {2}, . . . {N}). The resulting coordinates of the center of gravity (CG) of the vehicle due to the Galilean transformations are shown in Eqs. (8) and (9):

$${x}_{CG} ( Δ t ) = {\sum }_{t = 0}^{t = Δ t - δ t} ( {V}_{x , t} cos ( {\sum }_{i = 0}^{i = t} {ω}_{z , i} δ t ) - {V}_{y , t} sin ( {\sum }_{i = 0}^{i = t} {ω}_{z , i} δ t ) ) \qquad Eq , ( 8 )$$

$${y}_{CG} ( Δ t ) = {\sum }_{t = 0}^{t = Δ t - δ t} ( {V}_{y , t} cos ( {\sum }_{i = 0}^{i = t} {ω}_{z , i} δ t ) + {V}_{x , t} sin ( {\sum }_{i = 0}^{i = t} {ω}_{z , i} δ t ) ) \qquad Eq , ( 9 )$$

wherein x_{CG} and y_{CG} are the locations of the center of gravity of the host vehicle, V_{x,t} represents Vₓ at a discrete step t, and V_{y,t} represents V_{y} at a discrete step t, where t ranges from 0 to Δt. The term

$${\sum }_{i = 0}^{i = t} {ω}_{z , i} δ t$$

within the trigonometric terms calculates the accumulated sum of heading changes over time. Once the location (x_{CG}, y_{CG}) is determined at t−N by the Galielan transformation, the location can be compared to last known location received at time t−N to determine an estimated location 804 for the lane marker at time t−N. The estimated location 804 can then be used to generate an attraction field 806.

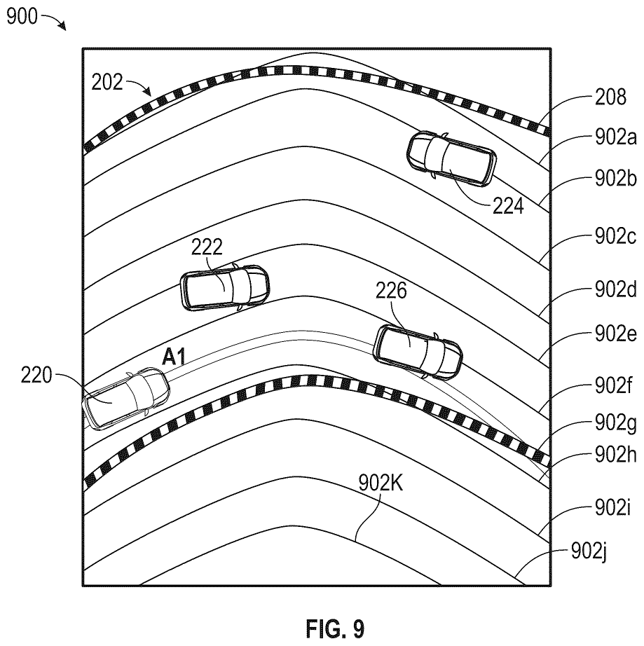

FIG. 9 is a top view 900 of the road section 202 showing various attractor potentials 902a-902h based on generated lane marker locations.

Returning to Eq. (1), steering wheel angle u is used as input to the cost function. The steering wheel angle at a time step k is given as uₖ, which is bounded various constraints, as shown in Eqs. (10)-(11):

$$\begin{matrix}{u}_{min} ( k , i ) \leq {u}_{c} ( k , i ) \leq {u}_{max} ( k , i ) & ∀ i \leq {n}_{u}\end{matrix} \qquad Eq . ( 10 )$$

$$\begin{matrix}Δ {u}_{min} ( k , i ) \leq {u}_{c} ( k , i ) - {u}_{c} ( k - 1 , i ) \leq Δ {u}_{max} ( k , i ) & ∀ i \leq {n}_{u}\end{matrix} \qquad Eq . ( 11 )$$

$${y}_{min} ( k , i ) - {V}_{{y}_{min}} ( j ) {ϵ}_{l} ( k , j ) \leq y ( k , i ) \leq {y}_{max} ( k , j ) + {V}_{{y}_{max}} ( j ) {ϵ}_{u} ( k , j ) \qquad Eq . ( 12 )$$

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
detecting a remote object in a road section;
determining a repelling potential associated with the remote object;
determining an attractor potential based on an estimated location of a lane marker;
determining a trajectory for the vehicle based on the repelling potential and the attractor potential;
creating a cost function for the vehicle based on the trajectory and at least one candidate steering command;
performing an optimization procedure on the cost function to determine an optimal steering command for the vehicle from the at least one candidate steering command; and
controlling a movement of the vehicle along the road section using the optimal steering command.

2. The method of claim 1, further comprising determining the repelling potential based on an inverse of a distance between the vehicle and the remote object.

3. The method of claim 2, further comprising defining a radius of awareness and determining the repelling potential as one of: (i) proportional to an inverse of the distance between the vehicle and the remote object when the distance is less than or equal to the radius of awareness; and (ii) zero when the distance is greater than the radius of awareness.

4. The method of claim 1, further comprising determining the attractor potential using a lateral distance between the vehicle and the estimated location of the lane marker.

5. The method of claim 1, further comprising determining the estimated location of the lane marker by performing a Galilean transformation on a current location of the vehicle using a longitudinal velocity of the vehicle and a lateral velocity of the vehicle at the current location of the vehicle.

6. The method of claim 1, further comprising creating the cost function when one of: (i) a malfunction of a camera occurs at the vehicle; and (ii) the road section has no lane markers.

7. The method of claim 1, wherein controlling the movement of the vehicle further comprises controlling a lateral movement of the vehicle.

8. A system for operating a vehicle, comprising:
a perception sensor configured to detect a remote object in a road section;
a processor configured to:
determine a repelling potential associated with the remote object;
determine an attractor potential based on an estimated location of a lane marker;
determine a trajectory for the vehicle based on the repelling potential and the attractor potential;
create a cost function for the vehicle based on the trajectory and at least one candidate steering command;
perform an optimization procedure on the cost function to determine an optimal steering command for the vehicle from the at least one candidate steering command; and
control a movement of the vehicle along the road section using the optimal steering command.

9. The system of claim 8, wherein the processor is further configured to determine the repelling potential based on an inverse of a distance between the vehicle and the remote object.

10. The system of claim 9, wherein the processor is further configured to define a radius of awareness and determine the repelling potential as one of: (i) proportional to an inverse of the distance between the vehicle and the remote object when the distance is less than or equal to the radius of awareness; and (ii) zero when the distance is greater than the radius of awareness.

11. The system of claim 8, wherein the processor is further configured to determine the attractor potential using a lateral distance between the vehicle and the estimated location of the lane marker.

12. The system of claim 8, wherein the processor is further configured to determine the estimated location of the lane marker by performing a Galilean transformation on a current location of the vehicle using a longitudinal velocity of the vehicle and a lateral velocity of the vehicle at the current location of the vehicle.

13. The system of claim 8, wherein the processor is further configured to create the cost function when one of: (i) a malfunction of a camera occurs at the vehicle; and (ii) the road section has no lane markers.

14. The system of claim 8, wherein controlling the movement of the vehicle further comprises controlling a lateral movement of the vehicle.

15. A vehicle, comprising:
a perception sensor configured to detect a remote object in a road section;
an actuator for controlling a movement of the vehicle;
a processor configured to:
determine a repelling potential associated with the remote object;
determine an attractor potential based on an estimated location of a lane marker;
determine a trajectory for the vehicle based on the repelling potential and the attractor potential;
create a cost function for the vehicle based on the trajectory and at least one candidate steering command;
perform an optimization procedure on the cost function to determine an optimal steering command for the vehicle from the at least one candidate steering command; and
send the optimal steering command to the actuator to control a movement of the vehicle along the road section.

16. The vehicle of claim 15, wherein the processor is further configured to determine the repelling potential based on an inverse of a distance between the vehicle and the remote object.

17. The vehicle of claim 16, wherein the processor is further configured to define a radius of awareness and determine the repelling potential as one of: (i) proportional to an inverse of the distance between the vehicle and the remote object when the distance is less than or equal to the radius of awareness; and (ii) zero when the distance is greater than the radius of awareness.

18. The vehicle of claim 15, wherein the processor is further configured to determine the attractor potential using a lateral distance between the vehicle and the estimated location of the lane marker.

19. The vehicle of claim 15, wherein the processor is further configured to determine the estimated location of the lane marker by performing a Galilean transformation on a current location of the vehicle using a longitudinal velocity of the vehicle and a lateral velocity of the vehicle at the current location of the vehicle.

20. The vehicle of claim 15, wherein the processor is further configured to create the cost function when one of: (i) malfunction of a camera occurs at the vehicle; and (ii) the road section has no lane markers.
